(19) United States
(12) Patent Application Publication
(10) Pub. No.: US 2025/0097331 A1
(43) Pub. Date: Mar. 20, 2025

(54) Housing Assemblies

(71) Applicant: Google LLC, Mountain View, CA (US)

(72) Inventors: Trevor Matthew Cardiff, Walnut Creek, CA (US); Charles Barnard Woodhull, Glen Ellyn, IL (US); Warren Zachary Jones, Glen Ellyn, IL (US); Kliulai Chow-Yee, San Francisco, CA (US); Joseph L. Allore, Mundelein, IL (US); James Leonard Tanner, Glen Ellyn, IL (US)

(73) Assignee: Google LLC, Mountain View, CA (US)

(21) Appl. No.: 18/571,113

(22) PCT Filed: Dec. 16, 2022
(86) PCT No.: PCT/US2022/081827

§ 371 Date: Dec. 15, 2023

Related U.S. Application Data
(60) Provisional application No. 63/380,808, filed on Oct. 25, 2022.

(51) Int. Cl. H04M 1/02

(52) U.S. Cl. CPC H04M 1/0249

(57) ABSTRACT

Techniques and apparatuses are described that implement housing assemblies for computing devices. In aspects, a housing assembly includes an elongated side-frame element comprising a first metal and a cast internal frame comprising a second, different, metal. The melting point of the first metal is higher than the melting point of the second metal. The elongated side-frame element may include at least one elongated slot disposed on an inner surface of the elongated side-frame element, with the elongated slot oriented parallel to the elongated side-frame element. The slot may include at least one undercut. The cast internal frame may include an elongated interlock flange that extends from an internal frame body. The elongated interlock flange received into the elongated slot of the elongated side-frame element. This document also describes methods for manufacturing a computing device housing assembly and a product-by-process.

### BACKGROUND

Products that include stainless-steel housing assemblies are often perceived by consumers as having a higher quality than those manufactured of other materials. This perception is due to stainless steel's cosmetic finishing, heft, and density. However, a fully stainless-steel housing assembly is unduly heavy and frequently cost-prohibitive due to the increased manufacturing difficulties associated with working with and processing stainless-steel components. Additionally, a computing device product will typically have multiple component modules that need to be aligned, assembled, and attached within the housing assembly during the manufacturing process. The utilization of a fully stainless-steel housing assembly can greatly add to the complexity of manufacturing processes.

### SUMMARY

This document describes techniques and apparatuses directed to housing assemblies for computing devices. In aspects, the techniques and apparatuses include housing assemblies having a forged stainless-steel band and an integral die-cast aluminum internal frame.

In general, a first aspect of the present disclosure relates to a housing assembly that includes an elongated side-frame element and a cast internal-frame element. The elongated side-frame element includes at least one elongated slot disposed on an inner surface of the elongated side-frame element. The elongated slot is oriented parallel to the elongated side-frame element and includes at least one undercut. The elongated side-frame element formed from a first metal. The cast internal-frame element includes an elongated interlock flange that extends from an internal frame body. The elongated interlock flange is received into the elongated slot of the elongated side-frame element. The elongated interlock flange includes a seat that engages the undercut. The internal-frame element is formed of a second metal. The second metal is a different metal than the first, and the melting point of the first metal is higher than the melting point of the second.

In aspects, the first metal is stainless steel and the elongated side frame element is formed through machining. In aspects, the second metal is at least one of aluminum, an aluminum alloy, magnesium, or a magnesium alloy. In aspects, the elongated side frame element is forged stainless steel. In aspects, the elongated side frame element is forged stainless steel and the second metal is at least one of aluminum, an aluminum alloy, magnesium, or a magnesium alloy. In aspects, the elongated slot comprises an open first channel, the open first channel defining an aperture in a sidewall face of the elongated side frame element, and the undercut further comprises at least one second channel connected to the open first channel. In aspects, the aperture has a width smaller than a width of the second channel. In aspects, the elongated interlock flange extends orthogonally from the internal frame body. In aspects, the elongated slot has the form in cross section of at least one of a T shape, a lobed shape, or a hook shape. In aspects, the elongated side frame element is formed of a first metal that has a first melting point and the internal frame element is formed of a second metal that has a second melting point. In aspects, the first melting point is higher than the second melting point. In aspects, the first metal is a different metal than the second metal.

Another aspect of the present disclosure relates to a method of making a housing assembly that comprises at least one of: forming the elongated side-frame element through a machining process; or forming the elongated side-frame element through a forging process. In aspects, a method of making the housing assembly further comprises forming an elongated slot that includes at least one undercut in the side-frame element. In aspects, a method of making the housing assembly further comprises forming an internal-frame element through a diecasting process by molding the internal frame element into the side-frame element to form a housing sub-assembly.

This Summary is provided to introduce simplified concepts for housing assemblies for computing devices, which are further described below in the Detailed Description and are illustrated in the Drawings. This Summary is intended neither to identify essential features of the claimed subject matter nor for use in determining the scope of the claimed subject matter.

### BRIEF DESCRIPTION OF THE DRAWINGS

The details of one or more aspects of housing assemblies for computing devices are described in this document with reference to the following drawings, where the use of same numbers in different instances may indicate similar features or components:

FIG. 1 is an exploded perspective view of an example computing device, in accordance with this disclosure;

FIG. 2 is a partial perspective view of the computing device of FIG. 1;

FIG. 3 is a perspective cross-sectional view along line 3-3 in FIG. 2;

FIG. 4 is a side cross-sectional view along line 4-4 in FIG. 3;

FIG. 5A is a perspective cross-sectional view of a first workpiece during a first manufacturing process;

FIG. 5B is a perspective cross-sectional view of the first workpiece of FIG. 5A during a second manufacturing process;

FIG. 5C is a perspective cross-sectional view of the first workpiece of FIG. 5A during a third manufacturing process;

FIG. 6A is a partial side cross-sectional view of an aspect of a side-frame element including a cutting tool;

FIG. 6B is a partial side cross-sectional view of the view of FIG. 6A without the cutting tool;

FIGS. 7A-7K are partial cross-sectional views of examples of housing assemblies;

FIG. 8 is a plan view of a second workpiece; and

FIG. 9 is a plan view of a third workpiece.

### DETAILED DESCRIPTION

### Overview

This document describes techniques and apparatuses directed to housing assemblies for computing devices. In aspects, the housing assemblies include a forged stainless-steel band (side-frame element) and an integral die-cast aluminum internal-frame element.

### Operating Environment

The following discussion describes an operating environment, techniques that may be employed in the operating environment, and various devices or systems in which components of the operating environment can be embodied. In the context of the present disclosure, reference is made to the operating environment by way of example only.

A computing device (e.g., a smartphone) may include a housing assembly (e.g., enclosure) that defines a cavity configured to enclose one or more internal component modules (e.g., a main logic board, a display panel, a speaker assembly, a battery, sensors modules, and the like) of the computing device. The housing assembly may include one or more of a housing, frame, internal frame, midframe, mount, mounting structure, case, plate, front-panel element, display panel, sidewall, side frame, cosmetic band, back-panel element, cover, or portion thereof. In an example, a computing device housing assembly includes an internal-frame element, a front-panel element, a back-panel element, and a side frame that extends between the front-panel element and the back-panel element to enclose the internal component modules of the computing device. The internal frame may include the front-panel element and/or the back-panel element. The internal-frame element may attach to one or more of the side frame, front-panel element, or back-panel element and may support one or more of the internal component modules. The internal-frame element may be sandwiched between the front-panel element and the back-panel element.

### Housing Assemblies

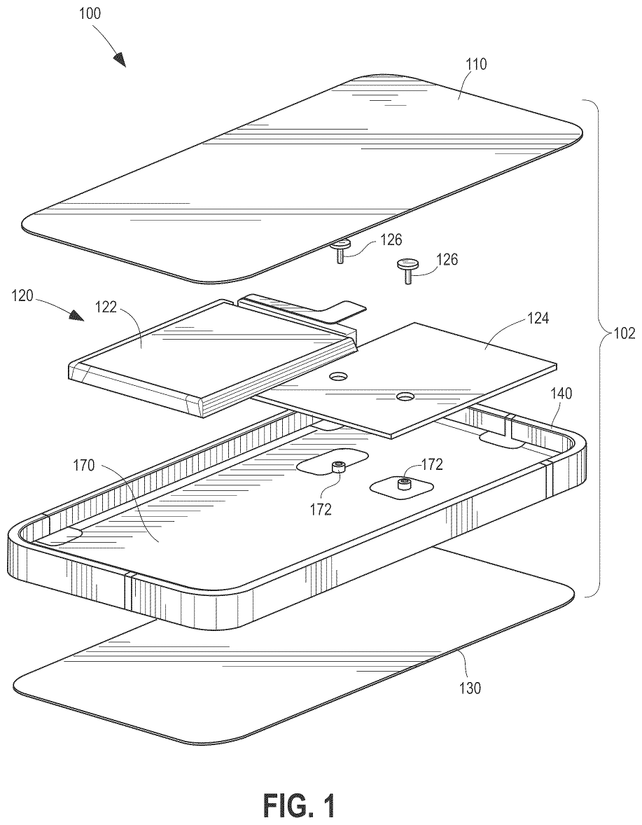

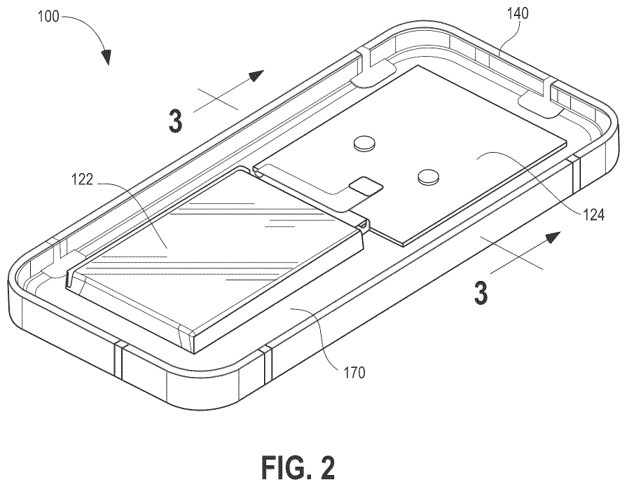

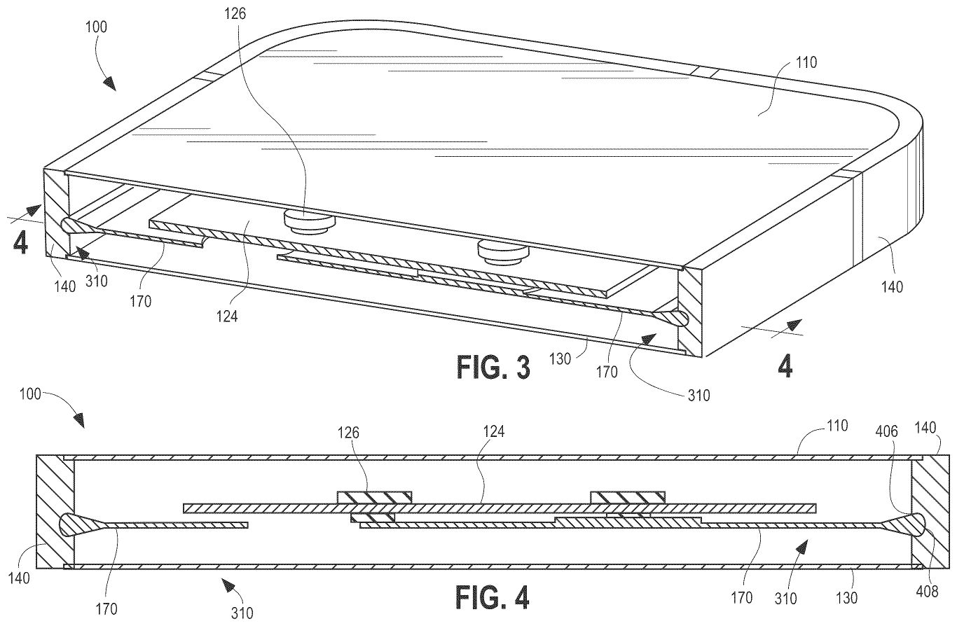

FIGS. 1, 2, 3, and 4 illustrate an aspect of a computing device 100 in which the techniques and apparatuses described in this publication may be implemented. FIG. 1 is an exploded, perspective illustration of the computing device 100. FIG. 2 is a partial illustration of the computing device 100 of FIG. 1, as assembled. FIG. 3 is a perspective, cross-sectional view along line 3-3 of FIG. 2. FIG. 4. is a side, cross-sectional view along line 4-4 of FIG. 3.

The computing device 100 includes a housing assembly 102 and internal component modules 120 (e.g., a battery 122, a main logic board 124). The housing assembly 102 has a front-panel element 110 (e.g., a cover glass, a display panel), a side-frame element 140 (side frame 140), an internal-frame element 170 (internal frame 170), and a back-panel element 130 (e.g., back panel 130). The front-panel element 110 is not illustrated in FIG. 2 in order to show the internal component modules 120 assembled into the housing assembly 102. The computing device 100 may include mechanical fasteners 126 (e.g., screws) that are configured for engagement with bosses 172 in the internal-frame element 170 or another portion of the housing assembly 102 to affix one or more of the internal component modules 120 to the housing assembly 102. The side-frame element 140 and the internal-frame element 170 may be integrally molded to form a housing sub-assembly 310.

The side-frame element 140 may be made from a first metal that has a first melting point (melting temperature). Example first metal materials include, but are not limited to, stainless steel and stainless-steel alloy. The side-frame element 140 may be forged or computer numerical control (CNC) machined. In an example, the first metal is stainless steel and the side-frame element 140 is a forged stainless-steel band. In another example, the first metal is stainless steel and the side-frame element 140 is a CNC machined stainless-steel band. Before die casting, the side-frame element 140 can be further machined and/or processed to enable a better interlock between the side-frame element 140 and the internal-frame element 170.

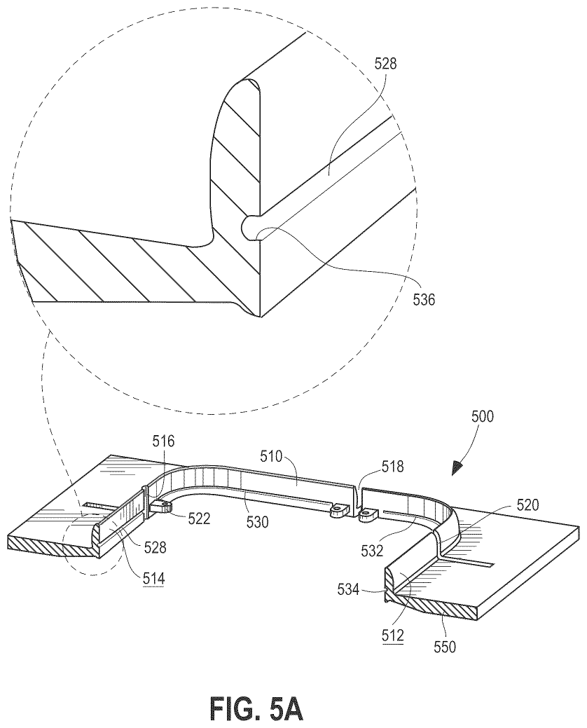

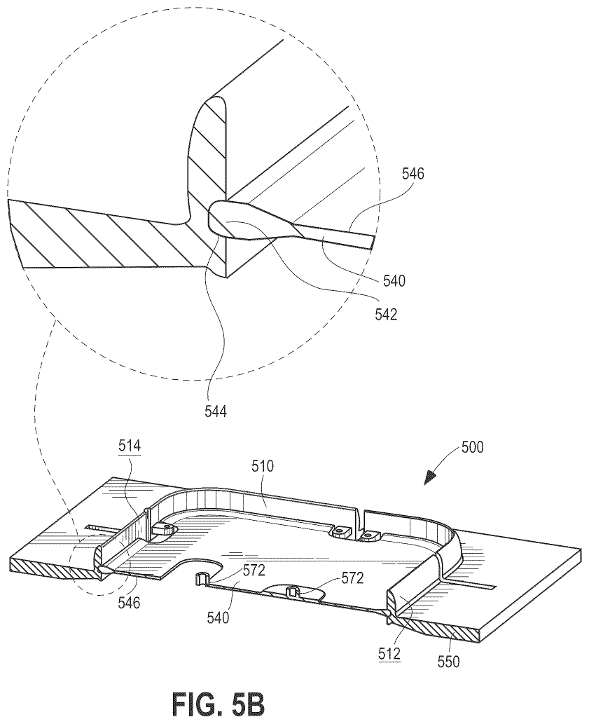

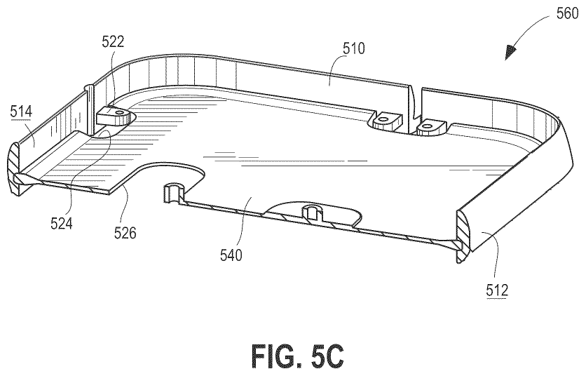

The side-frame element 140 includes at least one elongated slot 406 that includes at least one undercut 408, as described below in detail with respect to FIGS. 5A-5C. The elongated slot 406 can be formed through any acceptable means, including forging, turning, molding, and milling.

The internal-frame element 170 may be made from a second metal that has a second melting point (melting temperature). In aspects, the first melting point is higher than the second melting point. Example second metal materials include, but are not limited to, aluminum, aluminum alloys, magnesium, magnesium alloys, and the like. The internal-frame element 170 may be die-cast into the side-frame element 140. In an example, the second metal is aluminum and the internal-frame element 170 is a die-cast aluminum internal-frame element. In aspects, the second metal is a different metal than the first.

The housing sub-assembly 310, the front panel 110, internal component modules 120, and the back panel 130 are configured for assembly together to form the computing device 100. The housing sub-assembly 310 may be formed through a molding process whereby the internal-frame element 170 is formed in situ as well as molded into and secured to the side-frame element 140. An example of a molding process is illustrated in FIGS. 5A-5C. In the example of FIGS. 1-4, the housing sub-assembly 310 includes a machined stainless-steel side frame (e.g., side frame 140) molded with an integral die-cast aluminum internal frame (e.g., internal frame 170). In other examples, the stainless-steel side frame 140 may be formed through a forging process.

In FIG. 5A, a stock piece of a first material is placed in a fixture and is CNC machined (e.g., by a machine tool, such as a milling cutter), by removal of material, to form a workpiece 500. The workpiece 500 includes an elongated side-frame element 510 and a support structure 550 for supporting the side-frame element 510 during machining. In the aspect illustrated in FIG. 5A, the support structure 550 connects to and extends from an external-facing surface 512 of the side-frame element 510. The side-frame element 510 also includes an internal-facing surface 514.

The side-frame element 510 illustrated in FIG. 5A includes a number of gaps (516, 518, 520) defined through the side-frame element 510 that result in the side-frame element 510 including a plurality of elongated sidewall elements that may allow for isolation between multiple antennas of a computing device. In aspects, the gaps (516, 518, 520) may receive antenna split lines configured to permit radio frequency (RF) signals to pass through the housing assembly. In an example, an antenna line is configured of a material (e.g., a plastic material) that permits RF signals to pass through. In other aspects, the side-frame element 510 may be continuous, without interruption. The elongated side-frame element may be a single elongated side-frame element or, as illustrated in FIGS. 5A-5C, a plurality of elongated side-frame elements. In aspects, the antenna split lines may be formed in the side-frame element 510 after the molding of the internal-frame element.

The internal-facing surface 514 of the side-frame element 510 may define one or more supports (e.g., support 522) configured to support one or more of a front panel, an internal component module, or a back panel. For example, the support 522 includes a threaded aperture configured to receive a fastener (e.g., screw), enabling an internal component (e.g., internal component module 120) to be fastened to the side-frame element 510.

A further machining process is performed on the elongated side-frame element 510 to form at least one elongated slot in the internal-facing surface 514 of at least a portion of the side-frame element 510. The elongated slot may be oriented generally parallel to a length of the elongated side-frame element. In the aspect illustrated in FIG. 5A, four elongated slots are illustrated: elongated slot 528, elongated slot 530, elongated slot 532, and elongated slot 534.

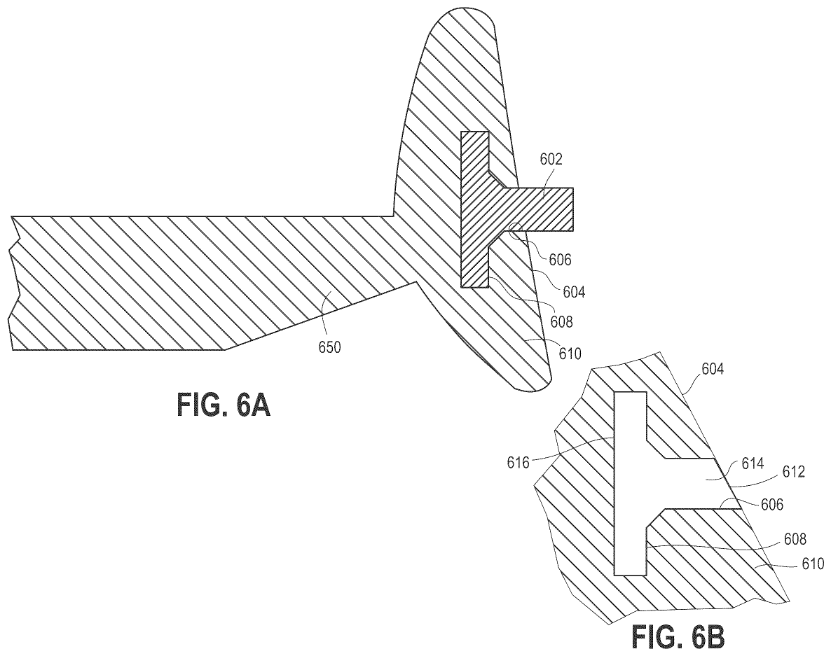

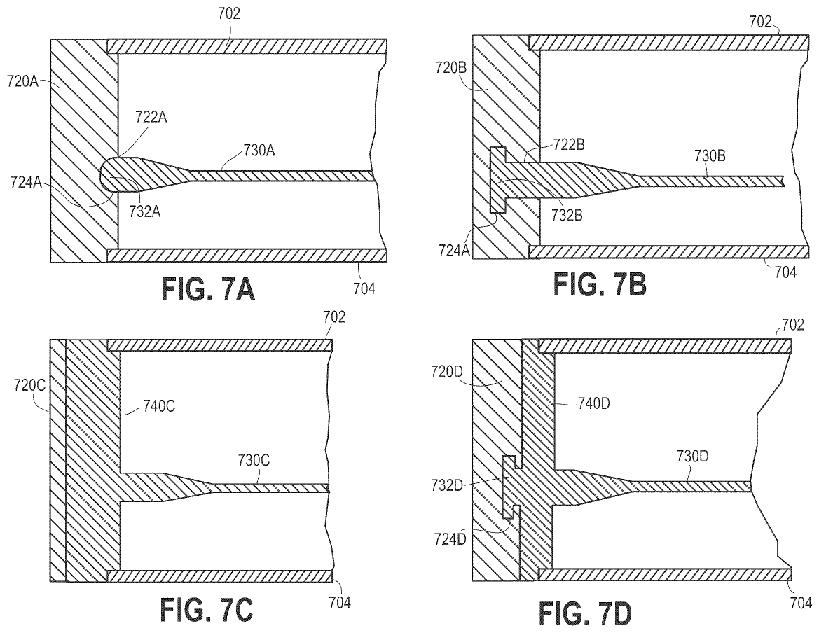

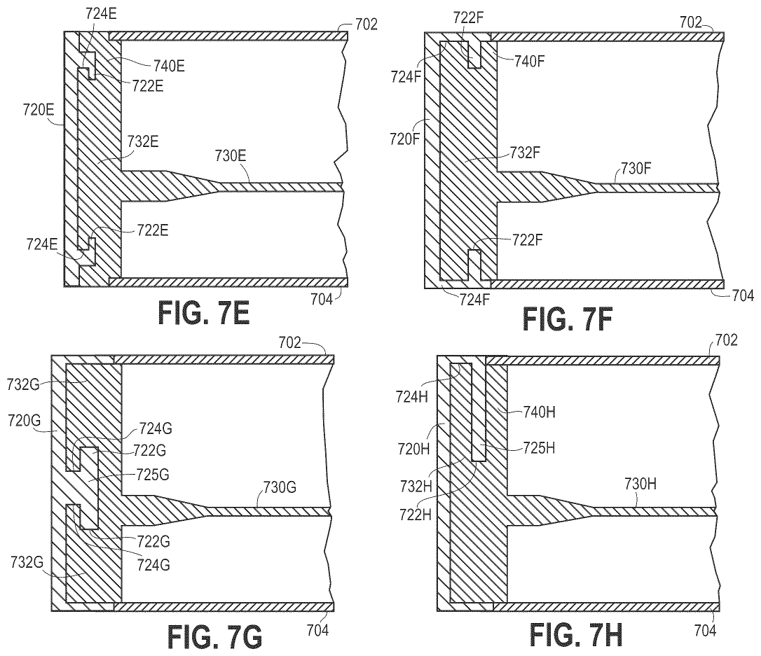

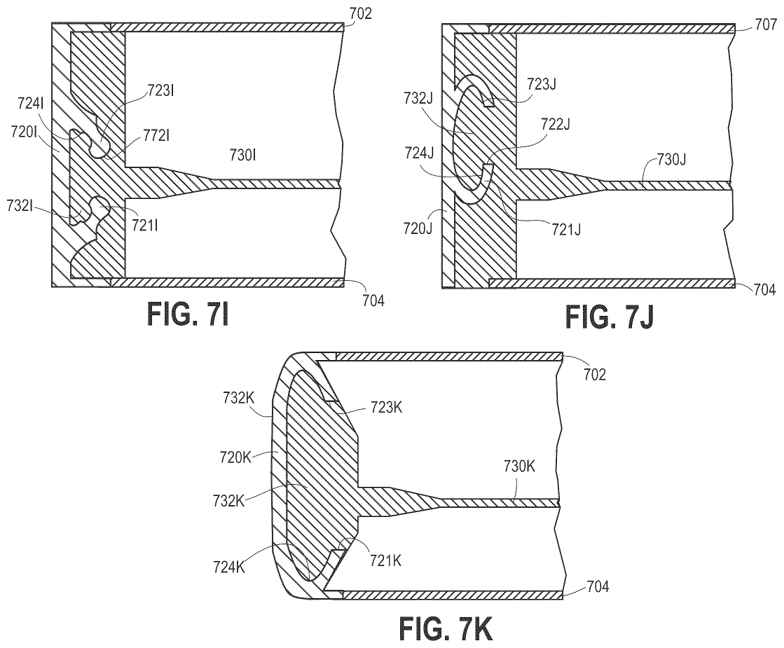

An elongated slot may include at least one undercut portion. The undercut portion provides a recessed surface that prevents withdrawal of an internal-frame element from engagement with the side-frame element. The undercut portion may be orthogonal to the orientation of the internal frame body. In the aspect illustrated in FIGS. 5A-5C, the elongated slot 528 includes an undercut 536. The elongated slot 528 in FIGS. 5A-5C forms a bulbous shape (e.g., a lobed shape). In other aspects, the elongated slot may form other shapes. For example, an elongated slot 606, has an undercut 608 and is illustrated in FIGS. 6A and 6B in a shape of a T-slot, which may be formed through T-slot milling. In another aspect (not illustrated), the elongated slot is in a shape of a dovetail slot. FIGS. 7A-7K, described below, illustrate additional examples of some shapes of elongated slots.

As mentioned above, the elongated slot can be formed through any acceptable means, including forging, turning, molding, and milling. In an example, illustrated in FIGS. 6A and 6B, a milling tool 602 is used to machine the elongated slot 606 in a side-frame element 610 (e.g., in a sidewall face 604 of the side-frame element 610). The elongated slot 606 may include at least one undercut 608. The elongated slot 606 defines an open first channel 614 that has an aperture 612 in the sidewall face 604. The undercut 608 defines a second channel 616. In aspects, the open first channel 614 and the second channel 616 are interconnected. The aperture 612 may have a width smaller than the width of the second channel 616.

The elongated slot 606 and the undercut 608 may be formed through separate processes through the use of one or more cutting tools. For example, a first milling cutter (e.g., end mill) may be used to cut the elongated slot 606 and then a second milling cutter (e.g., a T-slot end mill, side milling cutter) may be utilized to cut the undercut 608. In aspects, the machining process may include the use of a milling cutter to form linear ramping from the side-frame element into the elongated slot, for example by climb-milling, down-milling, up-milling, and the like. The machining process may include additional steps, including but not limited to drilling and tapping holes.

After the machining process described with respect to FIG. 5A, the workpiece 500 may be placed into the cavity of an injection molding tool (not illustrated). The internal-frame element 540 is then cast from a second metal material (e.g., aluminum, aluminum alloys, magnesium, magnesium alloys, and the like). For example, molten or semi-solid aluminum can be cast into the mold cavity, including into the elongated slot and into the undercut of the side-frame element to form the internal-frame element.

The internal-frame element 540 includes at least one elongated interlock flange (e.g., elongated interlock flange 542) that extends from an internal frame body 546 of the internal-frame element 540 and into an elongated slot (e.g., elongated slot 528) of the elongated side-frame element 510 to lock the internal-frame element 540 and the side-frame element 510 together. The elongated interlock flange includes a seat (e.g., seat 544) configured to engage the undercut (e.g. undercut 536), thereby securing the internal-frame element to the side-frame element. In aspects, the elongated interlock flange 542 extends orthogonally from the internal frame body 546 and is orthogonal to the elongated slot 528.

The internal-frame element 540 may define one or more bosses (e.g., boss 545) configured to engage a fastener (e.g., screw, tab, clip) to affix one or more internal component modules to the internal-frame element. In aspects, the bosses and other support structures (e.g., raised strengthening surfaces, ribs, stiffeners) may be formed through the molding process and/or through a machining process.

One or more apertures (e.g., aperture 524, aperture 526) may be defined through the internal-frame element 540 for routing or other purposes. For example, aperture 524 is defined adjacent to support structure 522, which extends from the internal-facing surface 514 of the side-frame element 510. In another example, the aperture 526 is defined in the internal-frame element 540 spaced apart from the side-frame element 510. In aspects, the apertures may be formed through the molding process and/or through a machining process.

After the internal-frame element and the side-frame element are molded together to form the housing sub-assembly 560, a further machining process may be performed on the workpiece 500 to remove the support structure 550, as illustrated in FIG. 5C. After the housing sub-assembly 560 is formed, it may be insert molded in a plastic injection mold machine to add additional features (e.g., plastic studs) and/or the housing sub-assembly may be further processed through clean-up CNC work and/or cosmetic finishing operations.

In another aspect, the housing sub-assembly 310 includes a forged stainless-steel side frame (e.g., side frame 140) molded with an integral die-cast aluminum internal frame (e.g., internal frame 170). A forged side frame may include features similar to a machined side frame, e.g., at least one elongated slot and undercut.

FIGS. 7A-7K each illustrate an aspect of a computing device housing assembly in which the techniques and apparatuses described in this publication may be implemented. The housing assemblies illustrated include each of a front-panel element 702 and a back-panel element 704, such as are described above with respect to FIGS. 1-4. As described above with respect to

FIGS. 5A-5C, FIG. 6A, and FIG. 6B, an elongated slot may include at an undercut (recessed surface) that together form a shape. FIGS. 7A-7K illustrate examples of additional shapes of elongated slots and undercuts, as described below. In other aspects, the undercut and elongated slot may form other shapes. Further, any of one or more of the features of one or more of the housing assemblies of FIG. 7A-7K may be combined or reorganized to provide a wide array of additional and/or alternate configurations.

FIGS. 7A-7K each illustrate respective side-frame elements 720A-720K that are molded with respective internal-frame elements 730A-730K, through the processes described above. For example, the molding process described and illustrated with respect to FIGS. 5A-5C. The side-frame elements 720A-720K include elongated slots 722A-722K defined into an internal-facing surface of the side-frame element, with each elongated slot having an undercut 724A-724K. Through the molding processes described above, the internal-frame elements 730A-730K having interlocking flanges 732A-732K that extend into the elongated slots/undercuts and lock the internal-frame elements to the side-frame elements. In aspects described with respect to FIGS. 7A-7K, the housing assembly may have an elongated slot with a form in cross-section of at least one of a T-shape, a bulbous shape, a hook shape, and the like.

In FIG. 7A, the elongated slot 722A and undercut 724A together form a bulbous-shaped receiver into which the interlock flange 732A of the internal-frame element 730A is formed, resulting in a bulbous-shaped interlock flange 732A. In FIG. 7B, the elongated slot 722B and undercut 724B together form a T-shaped receiver into which the interlock flange 732B of the internal-frame element 730B is formed, resulting in a T-shaped interlock flange 732B.

In the aspect of FIG. 7C, the internal-frame element 730C further includes at least one support 740C extending from the internal-frame element 730C to at least one of the front-panel element 702 or the back-panel element 704. In FIG. 7D, the elongated slot 722D and undercut 724D together form a T-shaped receiver into which the interlock flange 732D of the internal-frame element 730D is formed, resulting in a T-shaped interlock flange 732D. In the aspect of FIG. 7D, the internal-frame element 730D further includes at least one support 740D extending from the internal-frame element 730D to at least one of the front-panel element 702 or the back-panel element 704. In FIG. 7E, the elongated slot 722E and undercut 724E together form a T-shaped receiver into which the interlock flange 732E of the internal-frame element 730E is formed, resulting in a T-shaped interlock flange 732E. In the aspect of FIG. 7E, the internal-frame element 730E further includes at least one support 740E extending from the internal-frame element 730E to at least one of the front-panel element 702 or the back-panel element 704. In FIG. 7F, the elongated slot 722F and undercut 724F together form a T-shaped receiver into which the interlock flange 732F of the internal-frame element 730F is formed, resulting in a T-shaped interlock flange 732F.

In FIG. 7G, the elongated slot 722G and undercut 724G together form a T-shaped flange 725G extending from the side-frame element 720G into which the interlock flange 732G of the internal-frame element 730G is formed around. In FIG. 7H, the elongated slot 722H and undercut 724H together form a hook-shaped flange 725H extending from the side-frame element 720H into which the interlock flange 732H of the internal-frame element 730H is formed around. In the aspect of FIG. 7H, the internal-frame element 730H further includes at least one support 740H extending from the internal-frame element 730H to at least one of the front-panel element 702 or the back-panel element 704.

In FIG. 7I, the housing assembly includes at least one protrusion element extending from the side-frame element 7201 that defines the elongated slot 722I and the undercut 724I. In FIG. 71, the protrusion element is illustrated as a first protrusion 721I and a second protrusion 723I, the first and second protrusions angled towards one another and terminating in a bulb. The internal-frame element 730I includes an interlock flange 732I that locks into the elongated slot 722I and undercut 724I. The internal-frame element 730I further includes at least one support 740I extending from the internal-frame element 730I to at least one of the front-panel element 702 or the back-panel element 704.

In FIG. 7J, the housing assembly includes at least one protrusion element extending from the side-frame element 720J that defines the elongated slot 722J and the undercut 724J. In FIG. 7J, the protrusion element is illustrated as a first protrusion 721J and a second protrusion 723J, the first and second protrusions angled towards one another and forming a C-shape. The internal-frame element 730J includes an interlock flange 732J that locks into the elongated slot 722J and undercut 724J. The internal-frame element 730J further includes at least one support 740J extending from the internal-frame element 730J to at least one of the front-panel element 702 or the back-panel element 704.

In FIG. 7K, the side-frame element 720K includes at least one protrusion element extending from the side-frame element 720K that defines the elongated slot 722K and the undercut 724K. In FIG. 7K, the protrusion element is illustrated as a first protrusion 721K and a second protrusion 723K, the first and second protrusions angled towards one another and forming a C-shape. The outside surface 732K of the side-frame element 720K having a curved outside surface.

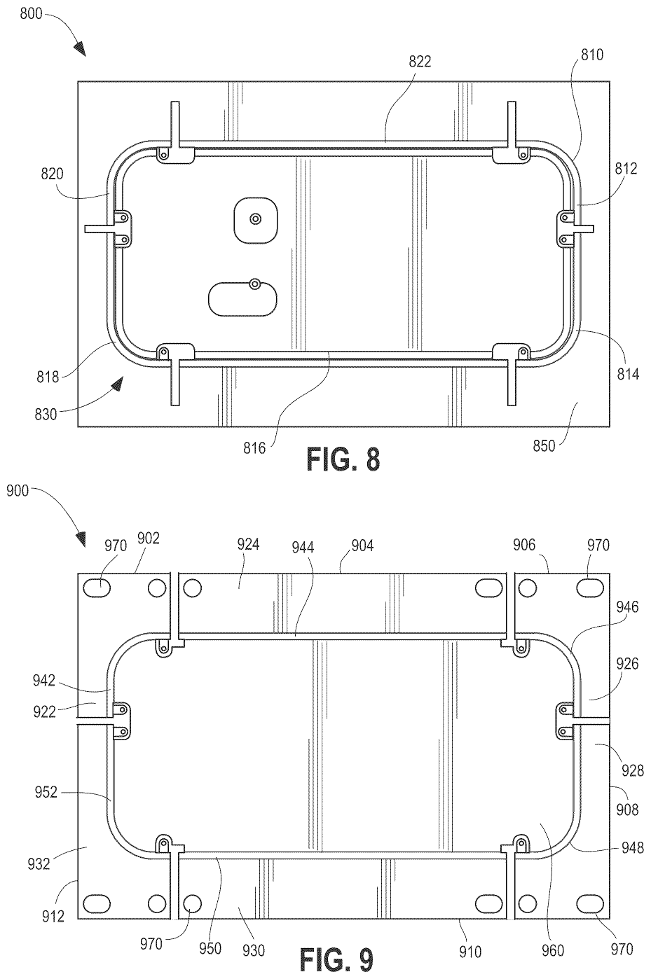

Illustrated in FIG. 8 is a workpiece 800 including a single support structure 850, a side-frame element 810, and a molded internal-frame element 840. The side-frame element 810 includes a plurality of side-frame elements (812, 814, 816, 818, 820, 822). The internal-frame element 840 interconnecting the side-frame elements of the side-frame element 810 together. In this Figure, the support structure 850 is illustrated as being formed of a single piece. After the molding of the internal-frame element 840 to the side-frame element 810 to form the housing sub-assembly 830, a machining process can be utilized to remove the support structure 850, for example, as is described above with respect to FIG. 5C.

Illustrated in FIG. 9 is a workpiece 900 formed of multiple forged side-frame element support assemblies (902, 904, 906, 908, 910, 912) and a molded internal-frame element 960. A respective side-frame element support assembly (902, 904, 906, 908, 910, 912) includes a respective support structure (922, 924, 926, 928, 930, 932) and a respective side-frame element (942, 944, 946, 948, 950, 952). After forging a side-frame element support assembly, one or more machining operations may be performed on the side-frame element support assembly, for example, to form one or more elongated slots and undercuts into the internal-facing surface of the side-frame element of the side-frame element support assembly. One or more alignment features 970 may be defined in one or more of the side-frame element support assemblies to provide for the alignment of the side-frame element support assemblies on a fixture (e.g., carrier plate) that is configured to keep the side-frame element support assemblies aligned during an operation of die casting the molded internal-frame element 960.

### Example Methods and Product-by-Process

Disclosed herein are also example methods for manufacturing a computing device housing assembly and a product-by-process. The methods are shown as a set of blocks that specify operations performed but are not necessarily limited to the order or combinations shown for performing the operations by the respective blocks. Further, any of one or more of the operations may be repeated, combined, reorganized, or linked to provide a wide array of additional and/or alternate methods. In portions of the following discussion, reference may be made to the example operating environment 100 of FIGS. 1-4 or to entities or processes as detailed in other figures (e.g., FIGS. 5A-5C, 6A, 8, and 9), reference to which is made for example only. The techniques are not limited to performance by one entity or multiple entities operating on one device. A product-by-process is further described.

In a first method, at a first operation, an elongated side-frame element of a first metal material is provided. At a second operation, at least one elongated slot disposed on an inner surface of the elongated side-frame element is formed therein. The elongated slot oriented parallel to the elongated side-frame element and the slot includes at least one undercut. At a third operation, the elongated side-frame element is placed in a mold cavity. At a fourth operation, a second metal is cast into the elongated slot and undercut to form an internal-frame element.

Through this operation, the internal-frame element is molded with the elongated side-frame element to form a housing sub-assembly. The first and second metal materials are different metal materials, with the first metal material having a higher melting point than the second metal material. At a fifth operation, the molded housing sub-assembly is ejected from the mold to form a molded part. The molded housing sub-assembly may be a product-by-process.

### Additional Examples

Some additional examples of techniques and apparatuses directed to housing assemblies for computing devices are as follows:

Example 1. A housing assembly comprising: an elongated side-frame element, the elongated side-frame element including at least one elongated slot disposed on an inner surface thereof, the elongated slot oriented parallel to the elongated side-frame element, the elongated slot including at least one undercut, the elongated side-frame element comprising a first metal; and a cast internal-frame element, the cast internal-frame element including an elongated interlock flange extending from an internal frame body, the elongated interlock flange received into the elongated slot of the elongated side-frame element, the elongated interlock flange including a seat, the seat engaging the undercut, the internal-frame element comprising a second metal, the second metal is a different metal than the first metal, and a melting point of the first metal is higher than a melting point of the second metal.

Example 2. The housing assembly of Example 1, wherein the first metal is stainless steel and the elongated side-frame element formed through machining.

Example 3. The housing assembly of any preceding Example, wherein the second metal is at least one of aluminum, an aluminum alloy, magnesium, or a magnesium alloy.

Example 4. The housing assembly of any preceding Example, wherein the elongated side-frame element is forged stainless-steel.

Example 5. The housing assembly of Example 4, wherein the second metal is at least one of aluminum, an aluminum alloy, magnesium, or a magnesium alloy.

Example 6. The housing assembly of any preceding Example, wherein the elongated slot comprises an open first channel, the open first channel defining an aperture in a sidewall face of the elongated side-frame element, and wherein the undercut further comprises at least one second channel connected to the open first channel.

Example 7. The housing assembly of any preceding Example, wherein the aperture has a width smaller than a width of the second channel.

Example 8. The housing assembly of any preceding Example, wherein the elongated interlock flange extends orthogonally from the internal frame body.

Example 9. The housing assembly of any preceding Example, wherein the elongated slot has the form in cross-section of at least one of a T-shape, a lobed shape, or a hook shape.

Example 10. The housing assembly of any preceding Example, where the elongated side-frame element is formed of a first metal that has a first melting point.

Example 11. The housing assembly of any preceding Example, where the internal-frame element is formed of a second metal that has a second melting point.

Example 12. The housing assembly of any preceding Example, wherein the first melting point is higher than the second melting point.

Example 13. The housing assembly of any preceding Example, wherein the first metal is a different metal than the second metal.

Example 14. The housing assembly of any preceding Example, wherein the housing assembly includes a machined stainless-steel side frame molded with an integral die-cast aluminum internal frame.

Example 15. A method of making the housing assembly of any preceding Example, comprising forming the elongated side-frame element through a machining process.

Example 16. The method of making the housing assembly of any preceding Example, wherein the machining process is a computer numerical control machining process.

Example 17. A method of making the housing assembly of any preceding Example, comprising forming the elongated side-frame element through a forging process.

Example 18. The method of making the housing assembly of any preceding Example, comprising further machining and/or processing the side-frame element to enable a better interlock between the side-frame element and the internal-frame element.

Example 19. The method of making the housing assembly of any preceding Example, further comprising forming an elongated slot that includes at least one undercut in the side-frame element.

Example 20. The method of making the housing assembly of any preceding Example, wherein forming the elongated slot is performed through at least one of forging, turning, molding, or milling.

Example 21. The method of making the housing assembly of any preceding Example, further comprising forming an internal-frame element through a diecasting process by molding the internal-frame element into the side-frame element to form a housing sub-assembly.

Example 22. The method of making the housing assembly of any preceding Example, wherein the housing sub-assembly includes a machined stainless-steel side frame molded with an integral die-cast aluminum internal frame.

Example 23. The method of making the housing assembly of any preceding Example, wherein forming an elongated side-frame element through a machining process comprises placing a stock piece of a first material in a fixture and CNC machining the stock piece (e.g., by a machine tool, such as a milling cutter) by removal of material to form a workpiece.

Example 24. The housing assembly of any preceding Example, wherein the workpiece includes an elongated side-frame element and a support structure for supporting the side-frame element during machining.

Example 25. The housing assembly of any preceding Example, wherein the support structure connects to and extends from an external-facing surface of the side-frame element.

Example 26. The housing assembly of any preceding Example wherein the side-frame element also includes an internal-facing surface.

Example 27. The housing assembly of any preceding Example, wherein the side-frame element includes a number of gaps defined through the side-frame element that result in the side-frame element including a plurality of elongated sidewall elements that allow for isolation between multiple antennas of a computing device.

Example 28. The housing assembly of any preceding Example, wherein the gaps receive antenna split lines configured to permit radio frequency (RF) signals to pass through the housing assembly.

Example 29. The housing assembly of any preceding Example, wherein an antenna split line is configured of a material (e.g., a plastic material) that permits RF signals to pass through.

Example 30. The housing assembly of any preceding Example, wherein the side-frame element is continuous, without interruption.

Example 31. The housing assembly of any preceding Example, wherein the elongated side-frame element is a single elongated side-frame element.

Example 32. The housing assembly of any preceding Example, wherein the elongated side-frame element is a plurality of elongated side-frame elements.

Example 33. The housing assembly of any preceding Example, wherein the antenna split lines are formed in the side-frame element after the molding of the internal-frame element.

Example 34. The housing assembly of any preceding Example, wherein the internal-facing surface of the side-frame element defines one or more supports configured to support one or more of a front panel, an internal component module, or a back panel.

Example 35. The housing assembly of any preceding Example, wherein the support includes a threaded aperture configured to receive a fastener (e.g., screw), enabling an internal component to be fastened to the side-frame element.

Example 36. The housing assembly of any preceding Example, wherein a further machining process is performed on the elongated side-frame element to form at least one elongated slot in the internal-facing surface of at least a portion of the side-frame element.

Example 37. The housing assembly of any preceding Example, wherein the elongated slot is oriented generally parallel to a length of the elongated side-frame element.

Example 38. The housing assembly of any preceding Example, wherein the elongated slot includes at least one undercut portion.

Example 29. The housing assembly of any preceding Example, wherein the undercut portion provides a recessed surface that prevents withdrawal of an internal-frame element from engagement with the side-frame element.

Example 30. The housing assembly of any preceding Example, wherein the undercut portion is orthogonal to the orientation of the internal frame body.

### Conclusion

Although implementations of techniques and apparatuses directed to housing assemblies for computing devices have been described in language specific to certain features and/or methods, the subject of the appended claims is not necessarily limited to the specific features or methods described. Rather, the specific features and methods are disclosed as example implementations for techniques and apparatuses directed to housing assemblies for computing devices.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, c-c-c, or any other ordering of a, b, and c). Further, items represented in the accompanying figures and terms discussed herein may be indicative of one or more items or terms, and thus reference may be made interchangeably to single or plural forms of the items and terms in this document.

1. A housing assembly comprising:
an elongated side-frame element, the elongated side-frame element including at least one elongated slot disposed on an inner surface thereof, the elongated slot oriented parallel to the elongated side-frame element, the elongated slot including at least one undercut, the elongated side-frame element comprising a first metal; and
a cast internal-frame element, the cast internal-frame element including an elongated interlock flange extending from an internal frame body, the elongated interlock flange received into the elongated slot of the elongated side-frame element, the elongated interlock flange including a seat, the seat engaging the undercut, the internal-frame element comprising a second metal, the second metal is a different metal than the first metal, and a melting point of the first metal is higher than a melting point of the second metal.

2. The housing assembly of claim 1, wherein the first metal is stainless steel, and wherein the elongated side-frame element formed through machining.

3. The housing assembly of claim 2, wherein the second metal is at least one of aluminum, an aluminum alloy, magnesium, or a magnesium alloy.

4. The housing assembly of claim 1, wherein the elongated side-frame element is forged stainless steel.

5. The housing assembly of claim 4, wherein the second metal is at least one of aluminum, an aluminum alloy, magnesium, or a magnesium alloy.

6. The housing assembly of claim 1,
wherein the elongated slot comprises an open first channel, the open first channel defining an aperture in a sidewall face of the elongated side-frame element, and
wherein the undercut further comprises at least one second channel connected to the open first channel.

7. The housing assembly of claim 6, wherein the aperture has a width smaller than a width of the second channel.

8. The housing assembly of claim 1, wherein the elongated interlock flange extends orthogonally from the internal frame body.

9. The housing assembly of claim 1, wherein the elongated slot has the form in cross section of at least one of a T-shape, a lobed shape, or a hook shape.

10. The housing assembly of claim 1, wherein the elongated side-frame element is formed of a first metal that has a first melting point and the internal-frame element is formed of a second metal that has a second melting point, wherein the first melting point and the second melting points are different melting points.

11. The housing assembly of claim 1, wherein the melting point of the first metal is higher than the melting point of the second metal.

12. The housing assembly of claim 1, wherein the first metal is a different metal than the second metal.

13-15. (canceled)

16. The housing assembly of claim 1, further comprising:
at least one gap defined through the elongated side-frame element, the gap dividing the elongated side-frame element into a plurality of elongated sidewall elements, the elongated sidewall elements configured to allow for isolation between multiple antennas of a computing device.

17. The housing assembly of claim 16, further comprising:
an antenna split line received into the gap, the antenna split line configured to permit radio frequency signals to pass through the housing assembly.

18. The housing assembly of claim 1, further comprising:
a panel element,
wherein the cast internal-frame element further comprises:
at least one support extending from the internal-frame element, the support configured for attaching to the panel element.

19. The housing assembly of claim 18,
wherein the panel element comprises:
a front-panel element; and
a back-panel element, and
wherein the at least one support extending from the internal-frame element comprises:
a first support configured for attaching to the front-panel element; and
a second support configured for attaching to the back-panel element.

20. A housing assembly for a computing device, the housing assembly comprising:
a stainless-steel elongated side-frame element formed through machining, the elongated side-frame element comprising:
at least one elongated slot disposed on an inner surface thereof, the elongated slot oriented parallel to the elongated side-frame element, the elongated slot comprising:
an open first channel, the open first channel defining an aperture in a sidewall face of the elongated side-frame element;
at least one undercut, the undercut including at least one second channel connected to the open first channel; and
at least one gap defined through the elongated side-frame element, the gap dividing the elongated side-frame element into a plurality of elongated sidewall elements, the elongated sidewall elements configured to allow for isolation between multiple antennas of the computing device; and
an internal-frame element formed through casting, the internal-frame element formed of at least one of an aluminum material, an aluminum alloy material, a magnesium material, or a magnesium alloy material, the internal-frame element comprising:
an internal frame body; and
an elongated interlock flange extending orthogonally from the internal frame body, the elongated interlock flange cast into the elongated slot of the elongated side-frame element, the elongated interlock flange including a seat, the seat engaging the undercut of the elongated side-frame element.

21. A method of manufacturing a housing assembly for a computing device, the method comprising:
forming an elongated side-frame element of a first metal material;
machining at least one elongated slot into an inner surface of the elongated side-frame element, the elongated slot oriented parallel to the elongated side-frame element, the elongated slot including at least one undercut; and
casting a second metal material into the elongated slot and undercut to form an internal-frame element, the second metal material a different material than the first metal material, the first metal material having a higher melting point than the second metal material.

22. The method of claim 21,
wherein the first metal material comprises at least one of stainless steel or a stainless-steel alloy, and
wherein the second metal material comprises at least one of aluminum, an aluminum alloy, magnesium, or a magnesium alloy.

23. The method of claim 21, further comprising:
machining antenna split lines in the side frame element.
